(19) United States
(12) Patent Application Publication
(10) Pub. No.: US 2009/0210150 A1
(43) Pub. Date: Aug. 20, 2009

(54) METHOD FOR SMART ANNOUNCING OF BUS STOP

(75) Inventor: Liao Shiun-Chih, Taichung City (TW)

Correspondence Address: NIKOLAI & MERSEREAU, P.A., 900 SECOND AVENUE SOUTH, SUITE 820, MINNEAPOLIS, MN, 55402, US

(73) Assignee: CHUNGHWA UNITED TELEVISION CO., LTD., Taichung City (TW)

(21) Appl. No.: 12/031,958

(22) Filed: Feb. 15, 2008

(51) Int. Cl. G01C 21/00; G01S 5/00

(52) U.S. Cl. 701/208

(57) ABSTRACT

A method for smart announcing of bus stop, includes using a navigation positioning device to receive signal from a satellite, retrieve current vehicle geographic longitude and latitude coordinates from the received signal, compare a databank thereof with the current geographic longitude and latitude coordinates to locate a special position value, such as a tunnel, and compute a distance from the current position to a next target position value, such as, a stop, based on the special position value and the current geographic longitude and latitude coordinates; and using a processing unit to receive data from the navigation positioning device, compute parameters for adjusting a remaining distance and the remaining distance based on the received data, and determine whether to drive an audio-visual device according to the remaining distance and the distance to the next target position value, so as to timely inform passengers of the arrival at the next stop.

### FIELD OF THE INVENTION

The present invention relates to a method for announcing bus stop, and more particularly to a method for smart announcing of bus stop.

### BACKGROUND OF THE INVENTION

Most of the mass transport vehicles, including high speed rail trains, mass rapid transit (MRT) trains, general trains, airplanes, etc., would announce the arrival at a stop via an intra-vehicle broadcasting system, so that passengers on the vehicle are informed of the name and other related information of the next stop. Under normal conditions, these mass transport vehicles are generally not affected by external factors to change the arrival time at each stop.

City bus is also a type of mass transportation vehicle having very close relation to people's daily life. In the early stages, most city buses have a female bus captain assigned thereto, end the female bus captain informs the passengers of the name of the next, stop before the city bus arrives at the stop. However, with the coming of electronic era, an electronic signboard provided in the city bus has replaced the female bus captain to display the name of the next stop.

FIG. 1 is a block diagram of a conventional bus stop announcing system 1, which includes a global positioning device 11 for receiving a positioning signal transmitted from a satellite 14, retrieving current vehicle geographic longitude and latitude coordinates and current vehicle speed from the received positioning signal, analyzing the current vehicle speed based on a basic vehicle speed, and sending the analyzed speed data to a microprocessor 12. The microprocessor 12 computes a predicted distance using the received speed data, so that a broadcasting device 13 is driven according to the predicted distance and a distance to the next stop.

When using the conventional bus stop announcing system 1 to perform the announcement of the arrival at a bus stop, the global positioning device 11 receives a positioning signal transmitted from the satellite 14, retrieves data of current vehicle geographic longitude and latitude coordinates and current vehicle speed from the received positioning signal, computes a distance between the current position and the next stop based on the current vehicle geographic longitude and latitude coordinates and coordinates of the next stop, analyzes the current vehicle speed based on a basic vehicle speed, and sends the analyzed speed data and the computed distance data to the microprocessor 12. The microprocesser 12 computes the predicted distance using the received speed data, so that the bus stop announcing system 1 drives the broadcasting device 13 according to the predicted distance and the distance to the next stop. While the above-described conventional bus stop announcing system is convenient for use, it has the following disadvantages:
1. When the bus passes through a tunnel, the global positioning device 11 is not able to transmit and receive signal to and from the satellite 14, and therefore, could not retrieve the current vehicle geographic longitude and latitude coordinates and the current vehicle speed to result in incorrect announcement of arrival at a next stop by the bus stop announcing system 1.
2. The bus stop announcing system 1 tends to drive the broadcasting device 13 earlier when the bus is in the tunnel and the next stop is located beyond the distance for broadcasting the arrival at the next stop. The incorrect announcement of arrival surely would cause inconveniences and confusions to the passengers.
3. In the event there is a stop closely located at an exit of the tunnel, and the global positioning device 11 does not have sufficient time to transmit and receive signal to and from the satellite, resulting in late driving of the broadcasting device 13 and accordingly, late announcement of the arrival at the stop by the bus stop announcing system 1. This also causes inconveniences and confusions to passengers.

Therefore, it is tried by the inventor to develop a method for smart announcing of bus stop through a smart bus stop announcing system to overcome the problem of interrupted signal transmission and receiving between a global positioning system (GPS) and a satellite and the failure in obtaining current vehicle geographic longitude and latitude coordinates and current vehicle speed when a bus is in a tunnel, so that a mass transportation vehicle may timely announce the next stop for passengers to have sufficient time to get ready for getting off without the risk of rushing to or staying at the bus door.

### SUMMARY OF THE INVENTION

A primary object of the present invention is to provide a method for smart announcing of bus stop to overcome the problem of interrupted signal transmission and receiving between a global positioning device and a satellite and the failure in obtaining current vehicle geographic longitude and latitude coordinates and current vehicle speed when a bus is in a tunnel, so as to announce next stop at most appropriate time.

To achieve the above and other objects, the method for smart announcing of bus stop according to the present invention is implemented through a smart bus stop announcing system having a navigation positioning device, a processing unit, and an audio-visual (AV) device. The navigation positioning device receives a satellite signal from a satellite and retrieves current vehicle geographic longitude and latitude coordinates from the received satellite signal. The navigation positioning device compares a databank thereof with the current vehicle geographic longitude and latitude coordinates to locate a special position value, such as a tunnel, and computes a distance from the current position to a next target position value, such as a stop, based on the special position value and the current vehicle geographic longitude and latitude coordinates. The processing unit of the bus stop announcing system receives data from the navigation positioning device and computes parameters for adjusting a remaining distance and the remaining distance, and determines whether to drive the AV device according to the remaining distance and the distance to the next target position value, so as to timely inform passengers of the arrival at the next stop.

### BRIEF DESCRIPTION 0F THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional bus stop announcing system;

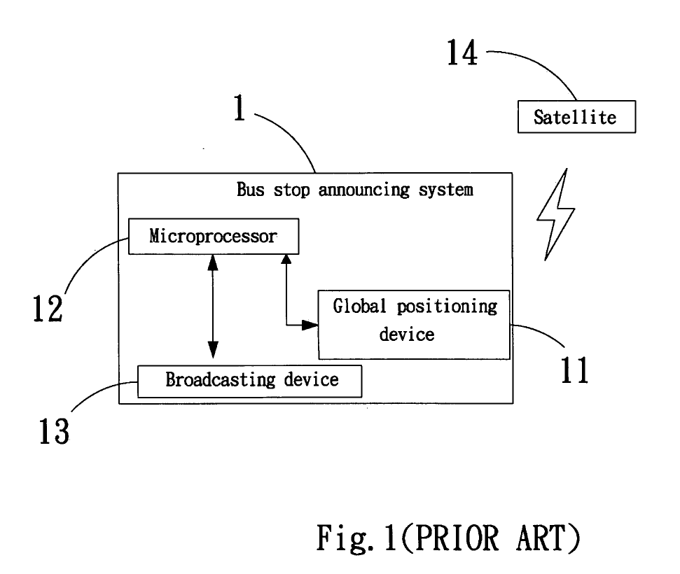

FIG. 2 is a block diagram of a smart bus stop announcing system for implementing a method for smart announcing of bus stop according to the present invention; and

FIG. 3 is a flowchart showing the steps includes in the method for smart announcing of bus stop according to the present invention.

### DETAILED DESCRIPTION OF THE PREFERRED EMBODIMENTS

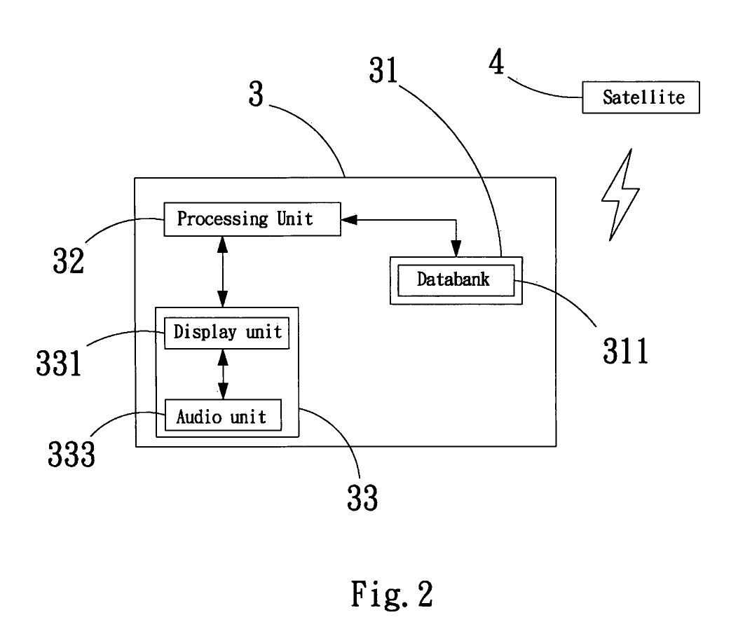

Please refer to FIG. 2 that is a block diagram of a smart bus stop announcing system 3 for implementing a method for smart announcing of bus stop according to the present invention applicable to a transport vehicle, such as a city bus. The smart bus stop announcing system 3 includes at least a navigation positioning device 31, a processing unit 32, and an audio-visual (AV) device 33. In a preferred embodiment of the present invention, the navigation positioning device 31 is provided with a databank 311 and a basic vehicle speed data. In the basic vehicle speed data, there is a preset vehicle speed per hour, such as, for example, 50 km. In the databank 311, there is a scheduled route data, such as electronic map information, and the scheduled route data includes at least one special position value and at least one target position, value. The special position value may be a tunnel position, and the target position value may be a bus station, a bus stop, etc. The navigation positioning device 31 is electrically connected to the processing unit 32, and the processing unit 32 is electrically connected to the AV device 33. The AV device 33 includes a display unit 331 and an audio unit 333. The display unit 331 maybe a liquid crystal display (LCD) for displaying text messages. The audio unit 333 may be a loudspeaker for sending out an audio message as an announcement.

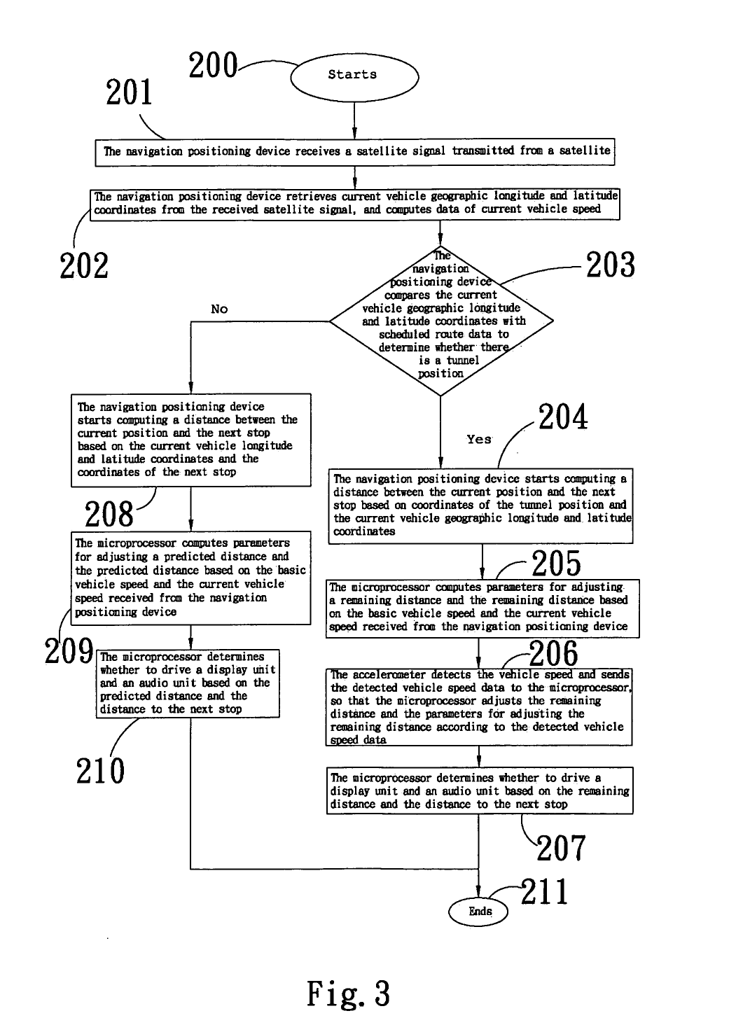

Please refer to FIG. 3 that shows the steps included in the method for smart announcing of bus stop according to the present invention. The navigation positioning device 31 of the smart bus stop announcing system 3 may transmit and receive signals to and from a satellite 4. When the bus approaches to and then enters into a tunnel, the smart bus stop announcing system 3 operates in the following steps:
(200) Starts operating;
(201) The navigation positioning device 31 receives a satellite signal front the satellite 4;
(202) The navigation positioning device 31 retrieves data of current vehicle geographic longitude and latitude coordinates based on the received satellite signal, and computes to obtain data of current vehicle speed;
(203) The navigation positioning device 31 compares the data of current vehicle geographic longitude and latitude coordinates with the scheduled route data to determine whether there is a tunnel position; if yes, the navigation positioning device 31 would perform the following step (204); and if not, the navigation positioning device 31 would perform the following step (207);
(204) The navigation positioning device 31 computes a distance between the current position and the next stop based on the coordinates of the tunnel position and the data of current vehicle longitude and latitude coordinates;
(205) The processing unit 32 computes parameters for adjusting a remaining distance and the remaining distance based on the basic vehicle speed data and the data of current vehicle speed received from the navigation positioning device 31;
(206) The system 3 determines whether to drive the display unit 331 and the audio unit 333 based on the remaining distance and the distance to the next stop; or
(207) The navigation positioning device 31 starts computing a distance to the next stop based on the current vehicle longitude and latitude coordinates and the coordinates of the next stop;
(208) The processing unit 32 computes the parameters for adjusting a predicted distance and the predicted distance based on the basic vehicle speed data and the current vehicle speed data received from the navigation positioning device 31;
(209) The system 3 determines whether to drive the display unit 331 and the audio unit 333 based on the predicted distance and the distance to the next stop; and
(210) Ends one cycle of operation.

Before the bus enters into a tunnel, the satellite 4 and the navigation positioning device 31 communicate with each other. When the satellite 4 transmits a satellite signal to the navigation positioning device 31, the latter analyzes and retrieves from the received satellite signal the current vehicle geographic longitude and latitude coordinates, and computes the current vehicle speed, so that the navigation positioning device 31 may compare the current vehicle geographic longitude and latitude coordinates with the scheduled route data to determine whether there is any tunnel position in the scheduled route data. If it is determined there is a tunnel position in the scheduled route data, the navigation positioning device 31 starts computing the distance to the next stop based on the coordinates of the tunnel position and the current vehicle geographic longitude and latitude coordinates. When the distance to the next stop is obtained, the navigation positioning device 31 analyzes the current vehicle speed data based on the basic vehicle speed data. The analyzed vehicle speed data and the distance data are simultaneously sent to the processing unit 32. The processing unit 32 computes the parameters for adjusting the remaining distance and the remaining distance based on the received vehicle speed data, and determines whether to drive the display unit 331 and the audio unit 333 according to the remaining distance and the distance to the next stop, so that passengers on the bus may be timely informed of the arrival at the next stop and get ready for getting off the bus.

On the other hand, if it is determined no tunnel is found from the comparison of the current vehicle geographic longitude and latitude coordinates with the scheduled route data, the navigation positioning device 31 starts computing the distance from the current position to the next stop based on the current vehicle geographic longitude and latitude coordinates and the coordinates of the next stop. When the distance to the next stop is obtained, the navigation positioning device 31 analyzes the current vehicle speed data based on the basic vehicle speed data. The analyzed vehicle speed data and the computed distance data are simultaneously sent to the processing unit 32. The processing unit 32 computes the parameters for adjusting the predicted distance and the predicted distance based on the received vehicle speed data, and determines whether to drive the display unit 331 and the audio unit 333 according to the predicted distance and the distance to the next stop, so that passengers on the bus may be timely informed of the arrival at the next stop and get ready for getting off the bus.

In computing the parameters for adjusting the remaining distance or the parameters for the predicted distance, as well as the remaining distance and the predicted distance, the processing unit 32 may utilize artificial neural system or a fuzzy system to control the computing, so that the computing of most appropriate bus stop announcing time can be achieved. Since the computing based on an artificial neural system or a fuzzy system belongs to a highly specialized technical field, and is not a subject matter of the present invention, it is not discussed in details herein.

In conclusion, the present invention advantageously provides a method for smart announcing of bus stop, which is implemented through a smart bus stop announcing system.

In the method of the present invention, when a bus is scheduled to pass through a tunnel, the smart bus stop announcing system computes the distance to the next stop and the remaining distance, and determines based on these distances whether to drive the AV device for passengers to timely know the soon arrival at the next stop. Therefore, the problem of not able to receive a positioning signal from the satellite when the bus is passing through a tunnel can be solved, and passengers may still timely know the arrival at the next stop.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method for smart announcing of bus stop applicable to a transport vehicle, the method being implemented through a smart bus stop announcing system having a navigation positioning device, a processing unit electrically connected to the navigation positioning device, and an audio-visual (AV) device electrically connected to the processing unit, and comprising the following steps:
the navigation positioning device receiving a satellite, signal transmitted by a satellite;
the navigation positioning device retrieving current vehicle geographic longitude and latitude coordinates from the received satellite signal, and computing to obtain data of current vehicle speed;
the navigation positioning device comparing a databank built therein with the current vehicle geographic longitude and latitude coordinates, and determining whether there is a special position value in a scheduled route, data set in the databank;
the navigation positioning device starting computing a distance from the current position to a next target position value in the scheduled route data, based on coordinates of the special position value and the current vehicle geographic longitude and latitude coordinates;
the processing unit computing parameters for adjusting a remaining distance and a remaining distance, based on basic vehicle speed data set in the navigation positioning device and the data of current vehicle speed; and
the AV device being driven based on the remaining distance and the distance to the next target position value to timely inform passengers of the arrival at the next stop.

2. The method for smart announcing of bus stop as claimed in claim 1, wherein, in computing the parameters for adjusting the remaining distance and the remaining distance, the processing unit may utilize an artificial neural system or a fuzzy system to control the computing, so that the computing of most appropriate bus stop announcing time can be achieved.

3. The method for smart announcing of bus stop as claimed in claim 1, wherein the AV device includes a display unit.

4. The method for smart announcing of bus stop as claimed in claim 1, wherein the AV device includes an audio unit.

5. The method for smart announcing of bus stop as claimed in claim 3, wherein the display unit is an LCD.

6. The method for smart announcing of bus stop as claimed in claim 4, wherein the audio unit is a loudspeaker.
